(19) United States
(12) Patent Application Publication
(10) Pub. No.: US 2026/0208711 A1
(43) Pub. Date: Jul. 23, 2026

(54) METHOD FOR CONTROLLING A DISC BRAKE FOR A VEHICLE

(71) Applicant: HITACHI ASTEMO FRANCE, Drancy (FR)

(72) Inventors: Abdessamed RAMDANE, Beauvais (FR); Philippe BOURLON, DAMMARTIN EN GOELE (FR); Antony AUGUSTE, Villiers-Sur-Marne (FR)

(21) Appl. No.: 19/141,090

(22) PCT Filed: Oct. 27, 2023
(86) PCT No.: PCT/EP2023/080159

§ 371 Date: Jun. 19, 2025

(30) Foreign Application Priority Data
Dec. 21, 2022 (FR) FR2214147

(51) Int. Cl. B60T 8/58; B60T 8/171; B60T 8/172; B60T 8/18; B60T 13/74; F16D 66/00

(52) U.S. Cl. CPC B60T 8/58; B60T 8/171; B60T 8/172; B60T 8/18; B60T 13/746; F16D 66/00; B60T 2240/00; B60T 2250/02; B60T 2250/04; F16D 2066/001; F16D 2066/005; F16D 2066/006

(57) ABSTRACT

A method for controlling a disc brake for a vehicle applied to a disc brake including brake pads, each carrying a lining and an electromechanical actuator intended to move the brake pads in such a way that the respective linings thereof clamp the disc in order to effect braking. According to this method, at the end of a braking operation, a movement of the brake pads is controlled depending on a state of thermal expansion of the disc and of the respective linings of the brake pads in such a way that, after the movement, a stroke length between the lining of each brake pad and the disc remains greater than 0 mm and less than a predetermined stroke length.

### TECHNICAL FIELD OF THE INVENTION

The invention relates to a method for controlling a disc brake for a vehicle. The invention also relates to a disc brake adapted to implement the method. Lastly, the invention also relates to a vehicle comprising at least one disc brake according to the invention.

### TECHNICAL BACKGROUND

An electromechanically actuated disc brake for a vehicle, for example for a motor vehicle, typically comprises an electric motor intended to provide a clamping force to a clamping member, such as a piston, in order to move brake pads carrying brake linings towards the disc in such a way that the linings of the brake pads clamp the disc to effect braking. The friction between the disc and the linings of the brake pads increases their temperatures and consequently their respective thermal expansions. This thermal expansion varies according to several parameters, such as parameters relating to the braking that has just been effected. When the braking has stopped, the disc and the linings of the brake pads gradually cool so that their respective thermal expansions decrease until they return to a normal state at room temperature.

As the braking stops, the brake pads are moved by the electromechanical actuator in such a way as to leave a gap between the disc and the linings of the brake pads located on each side of the disc. If this gap is too small, there is a risk that the linings of the brake pads remain in contact with the disc for a certain time after braking due to thermal expansion, thus creating undesired residual braking that can affect the dynamic behaviour of the vehicle. In addition, residual braking unnecessarily generates brake particles that contribute to air pollution. If the gap between the linings of the brake pads and the disc is too large, the response time between a braking command and the braking, and therefore the braking distance, are increased, which is not desirable in terms of vehicle operating safety.

Thus, when manufacturing a disc brake and in particular when determining the gap that will be left between the linings of the brake pads and the disc outside of a braking period, a choice must be made between a short response time, associated with a significant risk of residual braking, and no risk of residual braking, associated with a long response time.

### SUMMARY OF THE INVENTION

The invention aims in particular to enable a disc brake for a vehicle to have a short response time to a braking command together with a reduced risk of residual braking.

To this end, the invention relates to a method for controlling a disc brake for a vehicle, wherein the disc brake comprises brake pads each carrying a lining and an electromechanical actuator intended to move the brake pads in such a way that the respective linings thereof clamp the disc in order to effect braking, characterised in that, at the end of a braking operation, a movement of the brake pads is controlled depending on a state of thermal expansion of the disc and of the respective linings of the brake pads in such a way that, after this movement, a stroke length between the lining of each brake pad and the disc remains greater than 0 mm and less than a predetermined stroke length.

Thus, the position of the brake pads relative to the disc outside of a braking period is not fixed but varies depending on the state of thermal expansion of the linings of the brake pads and of the disc. By keeping the stroke length between the lining of each brake pad and the disc greater than 0 mm and less than a predetermined stroke length, a gap can be dynamically kept between the linings of the brake pads and the disc that is large enough to avoid causing residual braking and small enough to have a short response time following a braking command, thereby reducing the braking distance.

Since the stroke length between the lining of each brake pad and the disc is greater than 0 mm, none of the linings of the brake pads, whether that facing the first side of the disc or that facing the second side of the disc, is in contact with the disc outside of a braking period.

The predetermined stroke length is chosen in such a way that the response time to a braking command is as short as possible.

The invention may comprise one or more of the following optional characteristics, taken alone or in combination.

Advantageously, the predetermined stroke length is between 0.002 mm and 0.100 mm. The lengths in this range of stroke lengths are high enough to avoid the appearance of residual braking and low enough so that the response time to a braking command results in the shortest possible braking distance.

Advantageously, the state of thermal expansion of the disc and of the linings of the brake pads is determined during or at the end of the braking operation by determining a temperature of the disc and/or of the linings of the brake pads. Determining the temperature of the disc and/or of the linings of the brake pads is a reliable indicator of their state of thermal expansion.

Preferably, the state of thermal expansion of the disc and of the linings of the brake pads is determined using a lookup table or a physical mapping model linking a temperature of the disc and/or of the linings of the brake pads to their state of thermal expansion. This is a simple, reliable and economical way of determining the state of thermal expansion of the disc and of the linings of the brake pads based on their temperatures. The lookup table or the physical mapping model is for example established beforehand according to the brake characteristics, such as the composition of the linings of the brake pads.

Advantageously, the temperature of the disc and/or of the linings of the brake pads is estimated using at least one braking duration and/or one braking force. These are reliable indicators for estimating the temperature of the disc and/or of the linings of the brake pads. Thus, there is no need to use a temperature sensor to determine these temperatures, which is economical. It is understood that the longer the braking duration and the greater the braking force, the greater the increase in the temperature of the disc and of the linings of the brake pads during braking. It is also understood that the shorter the braking duration and the smaller the braking force, the lower the increase in temperature during braking.

Preferably, the temperature of the disc and/or of the linings of the brake pads is estimated by further using at least one parameter selected from a speed of the vehicle, a weight of the vehicle, or dimensions of the brake. It is understood that these parameters affect the increase in the temperature of the disc and of the linings of the brake pads during braking. Thus, using these parameters results in a better estimation of the temperature of the disc and of the brake pads. It is understood that the greater the speed of the vehicle during braking, the weight of the vehicle or the dimensions of the brake, the greater the increase in the temperature of the disc and of the linings of the brake pads during braking. According to other embodiments, other parameters are used to give a better estimation of the temperature of the disc and of the linings of the brake pads.

Advantageously, if, at the end of the movement of the brake pads, the presence of residual braking is detected, a movement of the brake pads is controlled in such a way as to increase the respective stroke lengths between each brake pad lining and the disc. This monitoring and detection of residual braking ensures that if, for any reason whatsoever, residual braking should appear, it will be detected and eliminated, thus avoiding its associated disadvantages. Residual braking is detected differently depending on the embodiments. According to a particular embodiment, a force sensor or observer determines the braking force and if the sensor or observer determines the presence of residual braking outside of a desired braking period, a movement of the brake pads is controlled in such a way as to increase the respective stroke lengths between each brake pad lining and the disc.

According to one embodiment, the presence of residual braking is detected if an undesired decrease in a speed of rotation of a wheel of the vehicle fitted with the disc brake is detected. This is a simple and effective way of detecting residual braking. It is also economical since it uses a sensor or observer of the speed of rotation of a wheel of the vehicle which is generally already present or used.

The invention also relates to an electromechanically actuated disc brake for a vehicle, comprising an electronic control unit adapted to control the implementation of the method as described previously.

Lastly, the invention also relates to a vehicle comprising at least one disc brake as described previously.

### BRIEF DESCRIPTION OF THE FIGURES

The invention will be better understood on reading the description which follows, given purely by way of non-limiting example and referring to the attached drawings, in which:

FIG. 1 is a view of a vehicle according to the invention;

FIG. 2 is a perspective view of a disc brake according to the invention;

FIG. 3 is a diagrammatic representation of the clamping member, the brake pads and the disc of a disc brake according to the invention shown during a braking operation;

FIG. 4 is a diagrammatic representation similar to FIG. 3, shown at the end of a braking operation.

### DETAILED DESCRIPTION

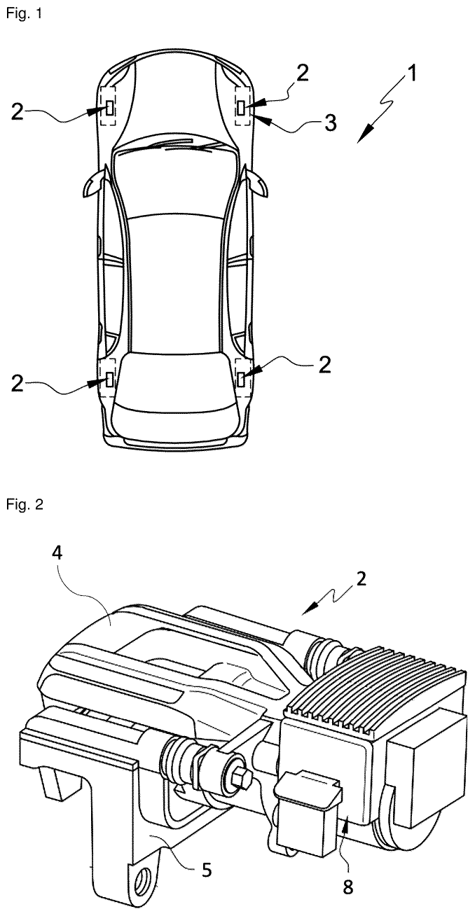

FIG. 1 shows a vehicle, in this case a motor vehicle 1, according to the invention, comprising at least two disc brakes 2, in this case four, fitted to each wheel 3 of the motor vehicle 1.

The invention applies to all types of brake, in particular those intended to be fitted on motor vehicles such as private vehicles, SUVs (Sport Utility Vehicles), two-wheeled vehicles (in particular motorcycles), aeroplanes, industrial vehicles selected from vans, “heavy goods vehicles”—in other words metro, bus, road transport vehicles (trucks, tractors, trailers), off-road vehicles such as agricultural or civil engineering vehicles—, or other transport or handling vehicles. The invention also applies to non-motorised vehicles such as in particular a trailer, a semi-trailer or a caravan.

FIG. 2 shows the brake 2 which is, in the present case, of the floating calliper disc type. Thus, it typically comprises a calliper 4 slidably mounted relative to a carrier 5 fixed relative to the motor vehicle 1.

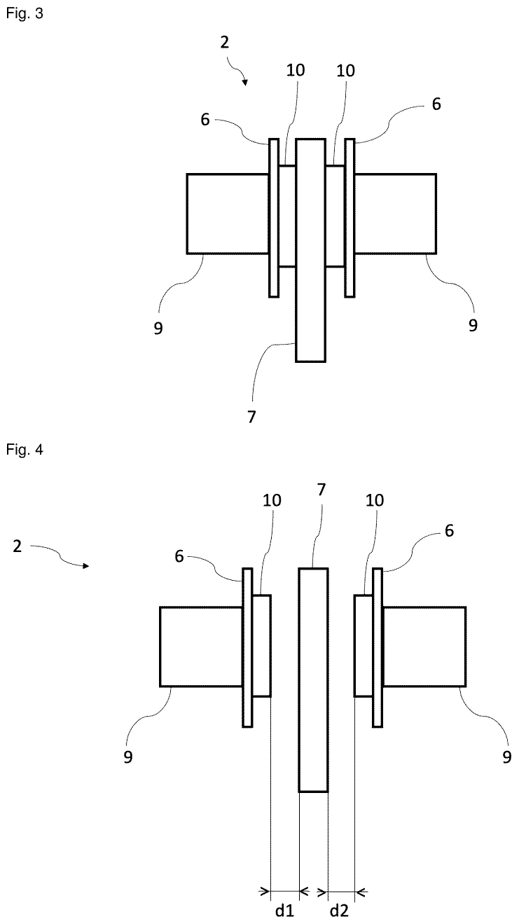

According to other embodiments, the brake 2 is of a different type, for example a fixed calliper disc brake 2 as shown on FIGS. 3 and 4.

Thus, as shown on FIGS. 3 and 4, the disc brake 2 comprises at least two brake pads 6 intended to cooperate by friction respectively with opposite sides of a disc 7 integral in rotation with one of the wheels 3 of the motor vehicle 1 in order to effect braking.

The disc brake 2 shown on FIGS. 3 and 4 further comprises an electric motor 8 intended to provide a clamping force to a clamping member 9, formed in this case by a piston, in order to move the brake pads 6 towards the disc 7 in such a way that the linings 10 of the brake pads 6 come into contact with the disc 7 and clamp it to effect the braking as shown on FIG. 3. During braking, the friction between the linings 10 of the brake pads 6 and the disc 7 increases the temperature of the linings 10 of the brake pads 6 and of the disc 7 and, consequently, their respective thermal expansions.

At the end of the braking operation, a movement of the brake pads 6 is controlled so that their respective linings 10 are no longer in contact with the disc 7 and, consequently, the wheels 3 of the motor vehicle 1 are no longer slowed down. The disc brake 2 comprises an electronic control unit (not shown) intended to control the operation of the disc brake 2 and in particular to control the movements of the clamping members 9 and therefore of the brake pads 6.

Note that the floating calliper brake 2 shown on FIG. 2 comprises elements not shown but similar to those shown diagrammatically on FIGS. 3 and 4 for the fixed calliper brake, in particular two brake pads intended to cooperate by friction respectively with opposite sides of a disc integral in rotation with one of the wheels 3 of the motor vehicle 1. Similarly, the floating calliper brake 2 shown on FIG. 2 comprises an electric motor intended to provide a clamping force to a clamping member in order to move the brake pads towards the disc.

A method for controlling the disc brake 2 according to the invention is described below, referring in particular to FIGS. 3 and 4. The electronic control unit is adapted to control the various steps described below. Although FIGS. 3 and 4 show a fixed calliper brake comprising a piston 9 on each side of the disc, it is understood that the implementation of the method for controlling a floating calliper brake 2 as shown on FIG. 2 does not depart from the scope of this invention, this brake 2 of FIG. 2 being controlled in a way similar to that described below.

According to this method, at the end of a braking operation, the movement of the brake pads 6 takes place depending on a state of thermal expansion of the disc 7 and of the respective linings 10 of the brake pads 6 in such a way that, after the movement, a stroke length d1, d2 between the lining 10 of each brake pad 6 and the disc 7 remains greater than 0 mm and less than a predetermined stroke length (see FIG. 4). By keeping the stroke length d1, d2 between the lining 10 of each brake pad 6 and the disc 7 greater than 0 mm and less than a predetermined stroke length, a gap can be dynamically kept between the linings 10 of the brake pads 6 and the disc 7 that is large enough to avoid causing residual braking and small enough to have a short response time following a braking command, thereby reducing the braking distance. Since the stroke length d1, d2 between the lining 10 of each brake pad 6 and the disc is greater than 0 mm, none of the linings 10 of the brake pads 6, whether that facing the first side of the disc 7 or that facing the second side of the disc 7, is in contact with the disc 7 outside of a braking period (see FIG. 4). According to this embodiment, the predetermined stroke length is between 0.002 mm and 0.10 mm.

It is understood that in order to satisfy the condition according to which the stroke length d1, d2 between the lining 10 of each brake pad 6 and the disc 7 remains greater than 0 mm and less than a predetermined stroke length, the brake pads 6 are moved as the linings 10 of the brake pads 6 and the disc 7 cool. In particular, it is understood that after a first axial movement in the direction away from the disc 7, the brake pads 6 are moved axially towards the disc 7 as cooling progresses and therefore as the thermal expansion decreases.

The state of thermal expansion of the linings 10 of the brake pads 6 and of the disc 7 is determined in different ways depending on the embodiments. In particular, this state of thermal expansion is either measured or estimated, for example using a thermal expansion observer.

According to this embodiment, the state of thermal expansion of the disc 7 and of the linings 10 of the brake pads 6 during or at the end of the braking operation is determined by determining a temperature of the disc 7 and/or of the linings 10 of the brake pads 6. Knowing the temperature of an element is a reliable way of determining its state of thermal expansion. Note that, according to the invention, the state of thermal expansion of the disc 7 and of the linings 10 of the brake pads 6 can both be determined by determining only the temperature of the disc 7. Similarly, the state of thermal expansion of the linings 10 of the brake pads 6 and of the disc 7 can both be determined by determining only the temperature of the linings 10 of the brake pads 6. In fact, since the temperature of the disc 7 and of the linings 10 are generally very close, it is possible, by determining the temperature of one of them, to deduce the temperature of the other with an acceptable degree of approximation. The method is simplified by determining the temperature of only one of these elements.

The estimated or measured temperature is for example used as input in a lookup table linking the temperature of the disc 7 and/or of the linings 10 of the brake pads 6 to their respective states of thermal expansion. This is a simple and economical way of determining the state of thermal expansion based on the temperature.

Depending on the embodiments, the temperature of the disc 7 and/or of the linings 10 of the brake pads 6 is measured or estimated. In the present case, the temperature of the disc 7 and of the linings 10 of the brake pads 6 is estimated using the duration or the force of the braking operation which has just taken place, the speed of the motor vehicle 1—in particular its change during the braking operation—, the weight of the vehicle and the dimensions of the brake 2. All these parameters can be used to obtain a precise estimation of the temperature of the disc 7 and of the linings 10 of the brake pads 6. According to other embodiments, fewer or more parameters can be used depending on the degree of precision required when determining the temperature and therefore the state of thermal expansion.

Advantageously, the method further comprises an additional step according to which if, at the end of the movement of the pads 6 as described above, the presence of residual braking is detected, an additional movement of the brake pads 6 is controlled in such a way as to increase the respective stroke lengths d1, d2 between each brake pad 6 lining 10 and the disc 7. Thus, if, at the end of the movement of the brake pads 6 taking place at the end of braking, it is detected that this movement, for any reason whatsoever, was not sufficient to avoid the presence of residual braking, this error is corrected to reduce the time during which the residual braking takes place.

The presence of residual braking is, for example, detected if an undesired decrease in the speed of rotation of a wheel 3 of the motor vehicle 1 fitted with the disc brake 2 is detected. To do this, a wheel rotation speed sensor, generally already present on the motor vehicle 1, can be used for example, which is economical.

The invention is not limited to the embodiment described and other embodiments will be clearly apparent to those skilled in the art.

### LIST OF REFERENCES

1: motor vehicle
2: disc brake
3: wheel
4: calliper
5: carrier
6: brake pads
7: disc
8: electric motor
9: clamping member
10: brake pad lining
d1, d2: stroke length between a brake pad lining and the disc

1. A method for controlling a disc brake for a vehicle, wherein the disc brake comprises brake pads each carrying a lining and an electromechanical actuator intended to move the brake pads in such a way that the respective linings thereof clamp the disc in order to effect braking, wherein, at an end of a braking operation, a movement of the brake pads is controlled depending on a state of thermal expansion of the disc and of the respective linings of the brake pads in such a way that, after the movement, a stroke length between the lining of each brake pad and the disc remains greater than 0 mm and less than a predetermined stroke length.

2. The method according to claim 1, wherein the predetermined stroke length is between 0.002 mm and 0.10 mm.

3. The method according to claim 2, wherein the state of thermal expansion of the disc and of the linings of the brake pads during or at the end of the braking operation is determined by determining a temperature of the disc and/or of the linings of the brake pads.

4. The method according to claim 3, wherein the state of thermal expansion of the disc and of the linings of the brake pads is determined using a lookup table linking a temperature of the disc and/or of the linings of the brake pads to their state of thermal expansion.

5. The method according to claim 4, wherein the temperature of the disc and/or of the linings of the brake pads is estimated using at least one braking duration and/or one braking force.

6. The method according to claim 5, wherein the temperature of the disc and/or of the linings of the brake pads is estimated by further using at least one parameter selected from a speed of the vehicle, a weight of the vehicle, or dimensions of the brake.

7. The method according to claim 1, wherein, if, at the end of the movement of the brake pads, the a presence of residual braking is detected, a movement of the brake pads is controlled in such a way as to increase the respective stroke lengths between each brake pad lining and the disc.

8. The method according to claim 7, wherein the presence of residual braking is detected if an undesired decrease in a speed of rotation of a wheel of the vehicle fitted with the disc brake is detected.

9. An electromechanically actuated disc brake for a vehicle, comprising an electronic control unit adapted to control an implementation of the method according to claim 1.

10. A vehicle comprising at least one disc brake according to claim 9.

11. The method according to claim 1, wherein the state of thermal expansion of the disc and of the linings of the brake pads during or at the end of the braking operation is determined by determining a temperature of the disc and/or of the linings of the brake pads.

12. The method according to claim 11, wherein the state of thermal expansion of the disc and of the linings of the brake pads is determined using a lookup table linking a temperature of the disc and/or of the linings of the brake pads to their state of thermal expansion.

13. The method according to claim 11, wherein the temperature of the disc and/or of the linings of the brake pads is estimated using at least one braking duration and/or one braking force.

14. The method according to claim 13, wherein the temperature of the disc and/or of the linings of the brake pads is estimated by further using at least one parameter selected from a speed of the vehicle, a weight of the vehicle, or dimensions of the brake.
